(19) United States
(12) Patent Application Publication
(10) Pub. No.: US 2012/0130142 A1
(43) Pub. Date: May 24, 2012

(54) AUTOMATICALLY MEASURING COLOR CHANGES IN A STREAM

(75) Inventors: Bruce R. Beadle, Kildeer, IL (US); Robert J.L. Noe, Mount Prospect, IL (US); Edward M. Casey, Mount Prospect, IL (US)

(73) Assignee: UOP, LLC, Des Plaines, IL (US)

(21) Appl. No.: 12/954,453

(22) Filed: Nov. 24, 2010

(51) Int. Cl. C10G 21/00; B01D 11/04

(52) U.S. Cl. 585/833; 210/634; 203/43

(57) ABSTRACT

One exemplary embodiment can be an extraction process. The extraction process can include extracting with a solvent degradable due to contact with oxygen, and automatically measuring the solvent to detect changes in the solvent color due to degradation.

### FIELD OF THE INVENTION

The present invention generally relates to automatically measuring color changes in a stream.

### DESCRIPTION OF THE RELATED ART

Sulfolane with a chemical name of 2,3,4,5,-tetrahydrothiaphene-1,1-dioxide can be used as a solvent in an extraction unit or an extractive distillation unit. Often, the solvent can be subject to degradation upon exposure to oxygen. Typically, air enters a unit as a contaminant in the hydrocarbon feed or make-up water, or through leaks, open drains, or vents in the equipment maintained under a vacuum, such as a solvent recovery column and associated equipment. Upon degradation due to exposure to oxygen in air, various acids can form. These acids may corrode vessels and equipment and provide free radicals that may catalyze olefin polymerization in the unit. The resulting polymers can plug and foul equipment. Particularly, very low concentrations of oxygen in sulfolane, such as one part per million, by weight, can cause measurable changes in the sulfolane pH.

In order to limit equipment corrosion and fouling from high molecular weight polymers, the pH of the sulfolane solvent in an extraction unit is typically monitored and neutralized with a basic chemical to form salts. Unfortunately, current state-of-the-art analyzers may not be able to reliably measure these oxygen concentrations. Often, typical practice for monitoring solvent degradation is to sample a lean solvent stream and water stream in the unit and conduct a pH measurement. Sampling may be infrequent as every eight hours or even delayed as long as once per year. Moreover, a measurement of pH and acid strength may provide a very rough estimate of solvent degradation and, typically, is very imprecise. A sudden or gradual increase in oxygen entering the unit may not be detected for an extended period and can allow considerable solvent degradation to take place before it is detected. Particularly, there can be a great variance among the samples, and there may be a delay in detecting a trend. As such, equipment damage and/or fouling may occur before remedial measures can be undertaken. As a consequence, there is a desire to provide a mechanism for readily monitoring these changes and prevent damage to the unit.

### SUMMARY OF THE INVENTION

One exemplary embodiment can be an extraction process. The extraction process can include extracting with a solvent degradable due to contact with oxygen, and automatically measuring the solvent to detect changes in the solvent color due to degradation.

Another exemplary embodiment can be a process for extracting one or more compounds from a hydrocarbon stream. The process can include contacting the hydrocarbon stream and a stream for extracting the one or more compounds where a degradation of the stream is automatically measured by an online colorimetric analyzer.

Yet another exemplary embodiment may be a process for recovering one or more aromatics from a hydrocarbon stream. The process can include contacting the hydrocarbon stream with a solvent for extracting the one or more aromatics, recovering a stream after contacting and separating at least a portion of the solvent; and recycling at least a portion of the recovered solvent where an automated online colorimetric analyzer is provided to measure a color of the recycled solvent prior to contacting.

The embodiments disclosed herein can provide frequent monitoring of the solvent utilized in a hydrocarbon or other processes. Particularly, the embodiments disclosed herein are applicable to any process utilizing a solvent that degrades and such degradation can be detected by a color change. As a result, the changes in the solvent color can be measured frequently and provide immediate notice for operators to identify the source of contamination and to make appropriate process changes and/or maintenance fixes to minimize damage to the process equipment. As a consequence, unit operations can be improved and the lifespan of the equipment may be extended.

### DEFINITIONS

As used herein, the term “stream” can include various hydrocarbon molecules, such as straight-chain, branched, or cyclic alkanes, alkenes, alkadienes, and alkynes, and optionally other substances, such as gases, e.g., hydrogen, or impurities, such as heavy metals, and sulfur and nitrogen compounds. The stream can also include aromatic and non-aromatic hydrocarbons. Moreover, the hydrocarbon molecules may be abbreviated C1, C2, C3 . . . Cn where “n” represents the number of carbon atoms in the one or more hydrocarbon molecules.

As used herein, the term “zone” can refer to an area including one or more equipment items and/or one or more sub-zones. Equipment items can include one or more reactors or reactor vessels, heaters, exchangers, pipes, pumps, compressors, and controllers. Additionally, an equipment item, such as a reactor, dryer, or vessel, can further include one or more zones or sub-zones.

As used herein, the term “rich” can mean an amount of at least generally about 50%, and preferably about 70%, by mole, of a compound or class of compounds in a stream.

As used herein, the term “substantially” can mean an amount of at least generally about 80%, preferably about 90%, and optimally about 99%, by mole, of a compound or class of compounds in a stream.

As used herein, the terms “automation”, “automated”, and derivatives thereof generally mean a system, method, and/or device where many or all of the movement and/or analysis of parts of the system, method, and/or device are performed and/or controlled by self-operating machinery and/or electronic devices.

As depicted, process flow lines in the figures can be referred to, interchangeably, as lines and stream.

### BRIEF DESCRIPTION OF THE DRAWINGS

FIG. 1 is a schematic depiction of an exemplary extraction zone.

FIG. 2 is schematic depiction of another exemplary extraction zone.

FIG. 3 is a depiction of a symbolic Lovibond color scale.

FIG. 4 is a symbolic depiction of clean and degraded solvent samples having approximate Lovibond color scale values.

### DETAILED DESCRIPTION

The embodiments disclosed herein can be utilized to provide continuous online monitoring of solvent color due to oxygen degradation by utilizing a suitable online colorimetric analyzer. Such solvents can be used in processes, such as aromatics extraction, sulfur extraction, alkene extraction, and natural gas purification for extracting compounds such as aromatics, sulfur, alkenes, hydrogen sulfide, carbon dioxide, and thiols. The oxygen-degradable solvents can include 2,3,4,5-tetrahydrothiophene-1,1-dioxide, i.e., sulfolane, 2-sulfolene, 3-sulfolene, 2-methylsulfolane, 2-4-dimethyl sulfolane, methyl-2-sulfonylether, N-aryl-3-sulfonylamine, ethyl-3-sulfonyl sulfide, 2-sulfonylacetate, ethylene glycol, diethyleneglycol, triethylene glycol, tetraethylene glycol, methoxy triethylene glycol, polyethyleneglycol, dipropyleneglycol, polypropyleneglycol, dimethylsulfoxide, glycol-amine, polyethyleneglycolether, N-methyl-2-pyrrolidone, and N-formyl morpholine. A variety of hydrocarbon processes may utilize one or more of these extraction solvents and methods.

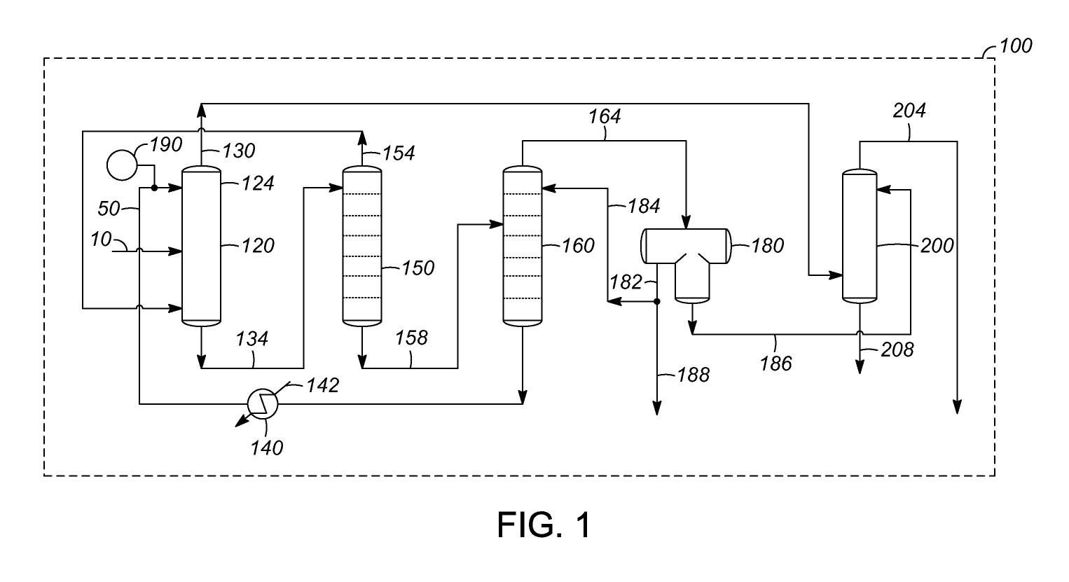

Referring to FIG. 1, an exemplary extraction zone 100 is depicted. The extraction zone 100 may include an extractor 120, an extractive stripper 150, a solvent recovery column 160, and a water wash vessel 200. An exemplary extraction unit is disclosed in, e.g., U.S. Pat. No. 3,953,324. A hydrocarbon stream 10 including one or more hydrocarbons and optionally containing recycled sulfolane may pass to the extractor 120.

A solvent stream 50, typically including a lean sulfolane, from a bottom of the solvent recovery column 160 may enter the extractor 120 near its top where the solvent can contact one or more hydrocarbons from the hydrocarbon stream 10. In the extractor, raffinate may separate from the extract. A raffinate overhead stream 130 from an upper end 124 of the extractor 120 consisting mostly of one or more saturated hydrocarbons along with small amounts of sulfolane can pass to the water wash vessel 200 where the one or more saturated hydrocarbons are contacted with water from a stream 186, including water, from an overhead stream 164 of the solvent recovery column 160, as described in further detail hereinafter. A raffinate stream 204 from an overhead of the water wash vessel 200 can pass to downstream units, such as one or more adsorbers, for removing residual sulfolane. A wash stream 208 consisting of sulfolane-rich water from the bottom of the water wash vessel 200 may be routed to any suitable destination, including the solvent recovery column 160.

A bottom stream 134 from the extractor 120 may be a fat solvent and pass to the extractive stripper 150 where heat and/or a stripping agent such as steam is employed to remove any saturates absorbed by the sulfolane in the extractor 120. An overhead stream 154 from the extractive stripper 150 may contain most of the saturates absorbed by the sulfolane in the extractor 120 then can be recycled to the extractor 120. A bottom stream 158, substantially a saturates-free fat-solvent, may pass from the extractive stripper 150 to the solvent recovery column 160.

In the solvent recovery column 160, heat is applied to remove the extract from the solvent. A solvent stream 50 from the bottom of the solvent recovery column 160 is a lean solvent that may pass through an exchanger 140 cooled with a cooling stream 142, such as water, before being returned to the extractor 120. An overhead stream 164, generally consisting of extract, water, and sulfolane, from the solvent recovery column 160 may be cooled in a condenser before passing to a receiver or overhead accumulator 180. Most of the water in the receiver 180 can accumulate in a boot and pass as the water stream 186 to the water wash vessel 200. A portion of a stream 182 from the receiver 180 can be employed as a reflux stream 184 in the solvent recovery column 160, while the remainder of an extract stream 188 may pass from an extraction zone 100, and be further processed in, e.g., an adsorption zone.

Typically, identifying a suitable location for an online colorimetric analyzer 190 is desirable for obtaining accurate, reliable, and reproducible data for allowing operators to detect changes in the extraction zone 100 operation. The online colorimetric analyzer 190 may be placed at a location having a suitable temperature for a withdrawn process stream. Measurements may be conducted at no more than about 180° C., preferably no more than about 120° C. In one exemplary embodiment, the online colorimetric analyzer 190 can be installed on a solvent stream 50 after being cooled in the exchanger 140 before return to the extractor 120.

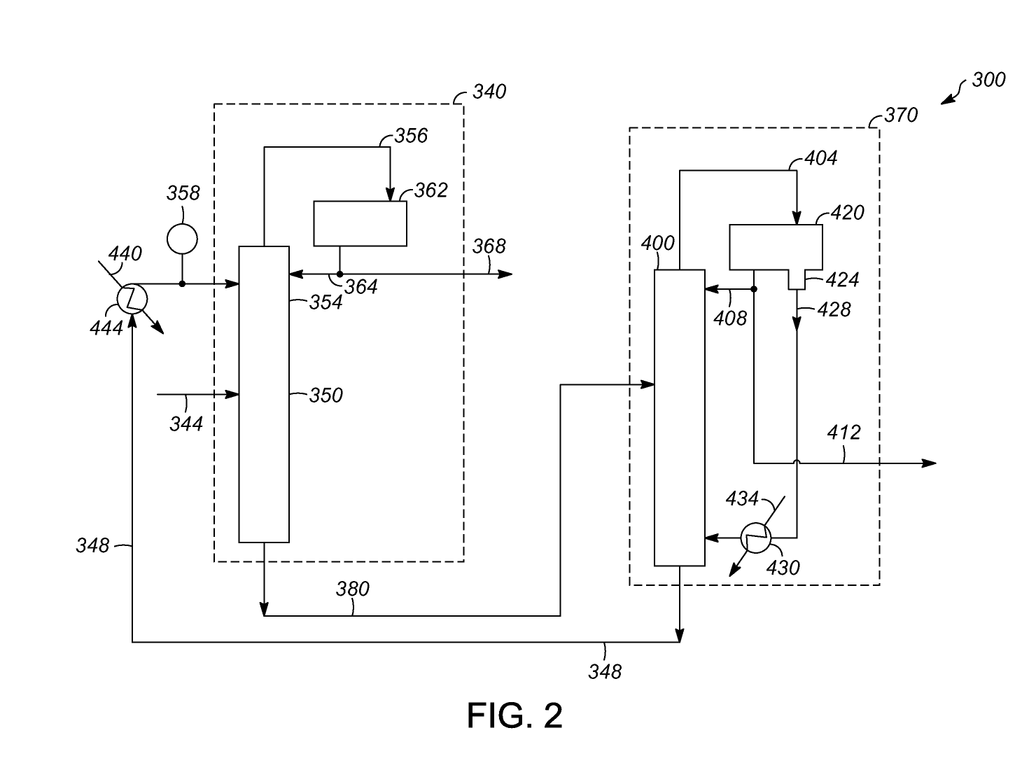

Another exemplary extraction zone 300 is depicted in FIG. 2, which can include an extractive distillation zone 340 and a second distillation zone 370. An exemplary extraction zone is disclosed in, e.g., U.S. application Ser. No. 12/782,570 filed 19 May 2010.

A feed stream 344 may be introduced to the extractive distillation zone 340 that can include an extractive distillation column 350. Exemplary extractive columns are disclosed in, e.g., U.S. Pat. No. 3,763,037 and U.S. Pat. No. 3,642,614.

A solvent stream 348 also may be introduced to extractive distillation zone 340. The solvent can include any suitable solvent as described above, such as sulfolane.

Typically, the feed stream 344 and the solvent stream 348 are contacted and separated in the extractive distillation column 350, optionally in the presence of water. Generally, a light or overhead stream 356, which typically includes substantially all of the non-aromatic components in the feed stream 344, is produced from an upper end 354 of the extractive distillation column 350. The light stream 356 may also include water and small amounts of aromatics and solvent. The extractive distillation column 350 can also produce a bottom stream 380, which can include substantially all of the feed stream 344 aromatic hydrocarbons and substantially all of the solvent introduced into the extractive distillation column 350. The bottom stream 380 may also include water and non-aromatic components.

The overhead stream 356 produced by extractive distillation column 350 may be condensed and collected in a receiver 362 and a portion returned to the extractive distillation column 350 as a reflux stream 364 while a remainder may be withdrawn from the extractive distillation zone 340 as a raffinate stream 368. If water is present, the receiver 362 may form a boot for collecting water, which may be removed separately from the receiver 362. The extractive distillation column 350 also may include a reboiler with the bottom stream 380 exiting the extractive distillation column 350 as a rich solvent stream. Typical operating conditions of extractive distillation column 350, which may have about 50—about 90 trays, can include a pressure of about 12—about 380 kPa, an overhead temperature of about 50—about 170° C., and a bottoms temperature of about 70—about 260° C. In an embodiment with a sulfolane solvent system, the bottoms temperature may be about 150—about 200° C. Generally, the solvent to feed volume ratio may be about 1:1—about 20:1 depending on the conditions in the column and the feed composition.

Usually, the bottom stream 380 including the solvent and the aromatic hydrocarbon is separated in the second distillation zone 370, which may include a second distillation column 400. The bottom stream 380 may also include water, non-aromatic components, and contaminants circulating in the process and/or introduced in the feed stream. Exemplary second distillation columns are disclosed in, e.g., U.S. Pat. No. 3,763,037 and U.S. Pat. No. 3,642,614. Desirably, the second distillation zone 370 is operated under conditions to separate the desired aromatic components from the solvent. The operating conditions may include the addition of water, usually in the form of steam, to the second distillation column 400 to improve the separation at a lower bottoms temperature in an effort to minimize solvent degradation.

Generally, the second distillation column 400 produces an overhead stream 404 that may include the aromatic hydrocarbon desired to be recovered from the feed stream 344, and optionally water. In an embodiment, the aromatic hydrocarbon is at least one of benzene, toluene, and xylene, and typically includes benzene, toluene, and xylene.

The overhead stream 404 produced by second distillation column 400 may be condensed in an overhead system and collected in a receiver 420 and a portion returned to the column as a reflux stream 408. The remainder may be withdrawn from the second distillation zone 370 as an extract stream 412, which may include the desired aromatic hydrocarbon. Optionally, the receiver 420 may form a water boot 424 for collecting water, if present, and be removed from the second distillation column 400. In one preferred embodiment, a water stream 428 can be removed from the water boot 424 and may be provided to an exchanger 430, which may act as a reboiler for the second distillation column 400. Any suitable heat source may be used with the exchanger 430, such as a process stream or pressurized steam, as a cooling stream 434.

The second distillation column 400 may separate a bottom stream 348, which may be recycled as the solvent stream 348 to the extractive distillation zone 340. The lean solvent stream 348 may also include water and at least one contaminant. Any contaminant may be removed utilizing any suitable system, such as a washing or an absorbent system. Before entering the extractive distillation zone 340, the lean solvent stream 348 may be passed through an exchanger 440 and cooled via a stream 444, such as any suitable process or water stream 444.

The online colorimetric analyzer 358 can be installed on the solvent stream 348 returning to the extractive distillation column 350. Preferably, the online colorimetric analyzer 358 is installed on a line after the solvent stream 348 passes through the exchanger 370, where measurements may be conducted at no more than about 180° C., preferably no more than about 120° C.

A color of a solvent can be unique to a given process unit. So, typically it is not the value of the solvent color measurement, but changes in the color measurement that can provide the requisite information for identifying any possible solvent contamination. It is common for such solvents to proceed from clear to dark amber in color. Once the contamination is identified, operators can conduct remedial measures, such as neutralizing the acids in the solvent, to eliminate contamination from process streams or repair leaks in equipment. Any suitable color or wavelength measurement system may be utilized. Although oxygen in air is one primary source of contamination, contamination may be caused by other sources of oxygen or other contaminates. If such contamination results in a color change of the solvent, then remedial steps may be undertaken. Particularly, a sudden change in solvent color may be noted by the operators. The exact color and degree of change may vary from unit to unit and remedial measures may be undertaken at the discretion of the operators based on experience.

In one exemplary embodiment, a Lovibond scale may be used. The Lovibond scale can be based on a calibrated series of red, yellow, and blue glasses. The Lovibond scale can be based on 84 calibrated glass color standards of different densities of magenta, yellow, and blue graduated from desaturated to fully saturated. Sample colors may be matched by suitable combination of three primary colors together with neutral filters resulting in a set that define the color. Particularly, the six divisions of the spectrum may be utilized, such as red, orange, yellow, green, blue and violet and these terms may be further clarified by terms such as bright and dull. A sample is described as being the nearest possible match with the appropriate category.

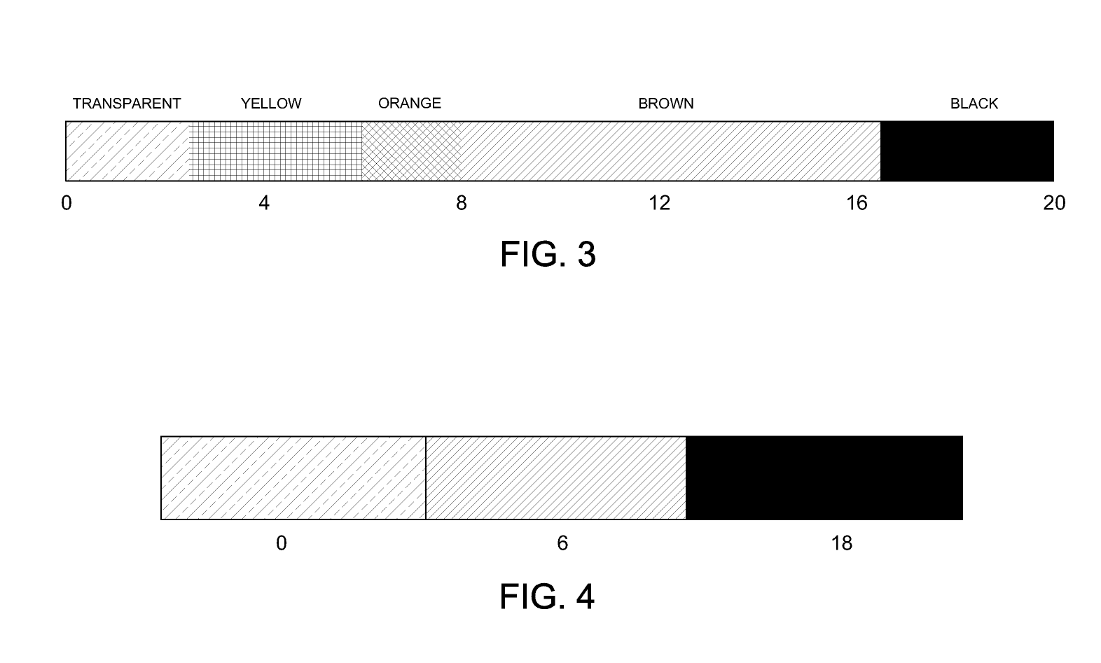

Referring to FIG. 3, a symbolic Lovibond color scale is depicted. The values can range from 0 to over 500. The colors can range in a continuum from clear or neutral to yellow, orange, light brown, dark brown, and black. The Lovibond color scale is often used in several industries including breweries. As such, the colors can be applied to pilsner beers, lager beers and stouts.

Referring to FIG. 4, three samples of colors are depicted from an aromatics extraction process utilizing a sulfolane solvent. As depicted in the figures, the colors can be characterized as clear or pilsner, brown or lager, and black or stout. Generally, the first solvent that is clean can be characterized on a Lovibond scale as 0. The second sample having a brown color can be characterized on the Lovibond scale as a 6, and the black sample can be characterized on the Lovibond scale as an 18. Generally, the solvent having a color of 0 on the Lovibond scale would be considered clean or uncontaminated, the color grade of 6 would be considered to be partly contaminated, and the color grade of 18 would be considered to be highly contaminated. Particularly, operating a process unit with the solvent having a grade of 0 would indicate that the unit solvent is operating adequately, a reading of 6 can indicate partial contamination and a desire for personnel to identify and stop the leak or source of contamination, and grade of 18 can indicate a highly contaminated solvent and a higher priority of identifying and stopping the leak or source of contamination. Often, a solvent regenerator can remove the undesired color from the solvent, but such a highly contaminated circulating solvent can increase the presence of acids and corresponding corrosion damage and fouling due to one or more polymers of the equipment.

Although the Lovibond scale can be used to measure color, other scales can be utilized as well. As an example, a Platinum-Colbalt/Hazen/APHA color measurement according to ASTM D1209-05e1 may be used well. This scale may also be referred to as a Platinum-Cobalt/Hazen or APHA Color. Typically, this scale is used to measure clear to dark amber liquids. Originally, it is defined by specific dilutions of a platinum-cobalt stock solution, ranging from 0 at a light end of the scale to 500 at a dark end. The scale is typically available in a digital format for automatic ranges of instruments with a resolution of one unit. This scale may be used extensively in the water industry, but also for clear oils, chemicals and petrochemicals, such as glycerin, plasticizers, solvents, carbon tetrachloride and petroleum spirits.

Any suitable online colorimeter may be utilized. Particularly, it is desirable for the colorimeter to take measurements fairly continuously and provide feedback to operators of any color changes to the solvent. One exemplary instrument is an AF26-EX dual channel adsorption sensor sold by optek-Danulat GmbH of Essen, Germany. Such an instrument can be installed on a line to measure the color changes in a solvent.

Installation of an online colorimetric analyzer on the circulating lean solvent stream can allow continuous monitoring of sulfolane solvent degradation. Sudden changes to oxygen entering the extraction unit can quickly be detected by measureable changes in solvent color. Such changes can trigger an alarm, enabling faster rectification and reduced operation disruption. Gradual changes due to slow oxygen contamination can also be detected and reliably compared across long periods of time. Continuous measurement of solvent color may allow improved monitoring of the effectiveness of the solvent.

A continuous online colorimetric analyzer device may be installed in the lean solvent stream, either directly on a line with the solvent or on a line containing a cooled slipstream, depending on the analyzer requirements. The analyzer should be installed in the coldest part of the lean solvent line, which is typically at the outlet of the last cooling exchanger before the lean solvent enters the extractor of an extracting unit or an extractive distillation column for an extractive distillation unit. The measurement signal from the analyzer may be sent to a control system where the measurement is displayed and recorded.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing, all temperatures are set forth in degrees Celsius and, all parts and percentages are by weight, unless otherwise indicated.

From the foregoing description, one skilled in the art can easily ascertain the essential characteristics of this invention and, without departing from the spirit and scope thereof, can make various changes and modifications of the invention to adapt it to various usages and conditions.

1. An extraction process, comprising:
A) extracting with a solvent degradable due to contact with oxygen; and
B) automatically measuring the solvent to detect changes in the solvent color due to degradation.

2. The process according to claim 1, wherein the automatic measurement is undertaken with an online colorimetric analyzer.

3. The process according to claim 1, wherein the solvent comprises at least one of 2,3,4,5-tetrahydrothiophene-1,1-dioxide, 2-sulfolene, 3-sulfolene, 2-methylsulfolane, 2-4-dimethyl sulfolane, methyl-2-sulfonylether, N-aryl-3-sulfonylamine, ethyl-3-sulfonyl sulfide, 2-sulfonylacetate, ethylene glycol, diethyleneglycol, triethylene glycol, tetraethylene glycol, methoxy triethylene glycol, polyethyleneglycol, dipropyleneglycol, polypropyleneglycol, dimethylsulfoxide, glycol-amine, polyethyleneglycolether, N-methyl-2-pyrrolidone, and N-formyl morpholine.

4. The process according to claim 1, wherein the solvent comprises 2,3,4,5-tetrahydrothiophene-1,1-dioxide.

5. The process according to claim 1, wherein at least one of an aromatic, a thiol, an alkene, hydrogen sulfide, carbon dioxide, and sulfur is extracted.

6. The process according to claim 1, further comprising identifying a source of contamination.

7. The process according to claim 6, further comprising remedying the source of contamination.

8. The process according to claim 1, wherein the color measurement is conducted at no more than about 180° C.

9. The process according to claim 1, further comprising passing a hydrocarbon stream for contacting the solvent in an extractor.

10. The process according to claim 1, further comprising passing a hydrocarbon stream for contacting the solvent in an extractive distillation column.

11. The process according to claim 1, further comprising neutralizing the solvent.

12. A process for extracting one or more compounds from a hydrocarbon stream, comprising:
A) contacting the hydrocarbon stream and a stream for extracting the one or more compounds wherein a degradation of the stream is automatically measured by an online colorimetric analyzer.

13. The process according to claim 12, further comprising measuring the stream degradation on a Lovibond scale.

14. The process according to claim 12, wherein a color measurement is conducted at no more than about 180° C.

15. The process according to claim 12, wherein a color measurement is conducted at no more than about 120° C.

16. A process for recovering one or more aromatics from a hydrocarbon stream, comprising:
A) contacting the hydrocarbon stream with a solvent for extracting the one or more aromatics;
B) recovering a stream after contacting and separating at least a portion of the solvent; and
C) recycling at least a portion of the recovered solvent wherein an automated online colorimetric analyzer is provided to measure a color of the recycled solvent prior to contacting.

17. The process according to claim 16, further comprising measuring solvent degradation on a Lovibond scale.

18. The process according to claim 16, wherein the solvent comprises at least one of 2,3,4,5-tetrahydrothiophene-1,1-dioxide, 2-sulfolene, 3-sulfolene, 2-methylsulfolane, 2-4-dimethyl sulfolane, methyl-2-sulfonylether, N-aryl-3-sulfonylamine, ethyl-3-sulfonyl sulfide, 2-sulfonylacetate, ethylene glycol, diethyleneglycol, triethylene glycol, tetraethylene glycol, methoxy triethylene glycol, polyethyleneglycol, dipropyleneglycol, polypropyleneglycol, dimethylsulfoxide, glycol-amine, polyethyleneglycolether, N-methyl-2-pyrrolidone, and N-formyl morpholine.

19. The process according to claim 16, wherein the solvent comprises tetrahydrothiophene-1,1-dioxide.

20. The process according to claim 16, wherein a color measurement is conducted at no more than about 180° C.
